(19) United States
(12) Patent Application Publication
(10) Pub. No.: US 2010/0093475 A1
(43) Pub. Date: Apr. 15, 2010

(54) CHAIN

(75) Inventor: Toshihiko Miyazawa, Osaka (JP)

Correspondence Address: HOWSON & HOWSON LLP, 501 OFFICE CENTER DRIVE, SUITE 210, FORT WASHINGTON, PA, 19034, US

(73) Assignee: TSUBAKIMOTO CHAIN CO.., Osaka (JP)

(21) Appl. No.: 12/555,860

(22) Filed: Sep. 9, 2009

(30) Foreign Application Priority Data
Oct. 14, 2008 (JP) 2008-264980

(51) Int. Cl. F16G 13/02

(52) U.S. Cl. 474/231

(57) ABSTRACT

In a roller chain or a rollerless bushing chain, each outer link plate is a gourd-shaped plate having, along the direction of elongation of the chain, a narrow middle portion between two end portions larger than the middle portion. The back height of each outer link plate, is smaller than the back height of each of the inner link plates. The area of each cross-section of each outer link plate, on a section plane perpendicular to the direction of chain elongation and passing through the center of a connecting pin, is at least as large as the area of each cross-section of each inner link plate taken on a section plane perpendicular to the direction of chain elongation and passing through the center of a bushing.

### CROSS-REFERENCE TO RELATED APPLICATION

This application claims priority on the basis of Japanese patent application 2008-264980, filed Oct. 14, 2008. The disclosure of Japanese application 2008-264980 is hereby incorporated by reference.

### FIELD OF THE INVENTION

This invention relates to a chain for use in a power transmission such as a power transmission mechanism in an automobile or industrial machine, or as part of a conveying mechanism or the like.

### BACKGROUND OF THE INVENTION

In a well-known type of chain, inner and outer links are arranged alternately along the length of the chain and interconnected with one another. Each inner link comprises a pair of opposed, spaced, inner link plates with a pair of cylindrical bushings having end portions press-fit into bushing holes in the link plates. Each outer link comprises a pair of opposed, spaced, outer link plates with a pair of connecting pins each press-fit into pin holes in both outer link plates. The plates of each of the outer links overlap plates of two adjacent inner links, and the two pins of each outer link extend rotatably through bushings of two adjacent inner links.

An example of the well-known conventional chain is shown in FIGS. 9, 10a, 10b and 11. The chain 500 comprises outer links 501, in which connecting pins 512 are fixed in pin holes of a pair of outer link plates 510, and inner links 502, in which bushings 522 are fixed in bushing holes 521 of a pair of inner link plates 520. The connecting pins 512 fit loosely in the bushings 522, connecting the inner and outer links in alternating sequence and allowing articulating movement of the connected links relative to one another.

The chain of FIG. 9 is a roller chain, having a roller 503 rotatable on each of the bushings 522.

In the chain 500, the outer link plates 510 of the outer links 501, and the inner link plates 520 of the inner links 502, each have an oval shape. If the distance from the chain pitch line P, shown in FIG. 11 to the outermost end surfaces 510b and 520b of each link plate is defined as the back height, the back height H of each outer link plate 510 is the same as the back height H of each inner link plate 520.

When the conventional chain 500 comes into sliding contact with a chain guide or the like, because the outer link plates 510 and the inner link plates 520 have the same back height H, both link plates 510 and 520 come into contact with the chain guide. Consequently, the contact area is large, and a large amount of is generated. Particularly, when the chain 500 is incorporated into an automobile engine as a timing chain, the large friction loss increases fuel consumption.

To address the problem of friction loss, the chain 600, shown in FIG. 12, has its gourd-shaped outer link plates 610, which have narrow intermediate parts, and a back height Ha lower than the back height Hb of the inner link plates 620. The outer link plates 610 do not come into contact with a chain guide or the like, and frictional resistance is consequently reduced. A chain of the kind shown in FIG. 12 is described in United States Patent publication 2007/0082776, published Apr. 12, 2007.

Because the outer links 610 are gourd shaped, and have narrow intermediate parts, and their back heights Ha are lower than the back heights Hb of the inner link plates 620, the strength of the outer link plates 610 is impaired and they are consequently liable to break.

An object of this invention is to provide a chain in which the area of contact with a chain guide is reduced so that frictional resistance is reduced, and noise and vibration are reduced, without significantly impairing the rupture strength of the chain.

### SUMMARY OF THE INVENTION

The chain according to the invention is an elongated chain comprising a series of inner and outer links arranged alternately along the length of the chain and interconnected with one another to form an endless loop. Each inner link comprises a pair of opposed, spaced, inner link plates with a pair of cylindrical bushings having end portions press-fit into bushing holes in the link plates. Each outer link comprises a pair of opposed, spaced, outer link plates with a pair of connecting pins each press-fit into pin holes in both outer link plates. The plates of each of the outer links overlap plates of two adjacent inner links, and the pins of each outer link extend rotatably through bushings of two adjacent inner links, thereby connecting the links to one another.

Each outer link plate is a gourd-shaped plate having, along the direction of elongation of the chain, a narrow middle portion between two end portions larger than the middle portion. The back height of each outer link plate, that is, the perpendicular distance from the chain pitch line drawn through the centers of the connecting pins in the plate to the part of the plate that is on the outer side of the loop, is smaller than the back height of each of the inner link plates. The area of each cross-section of each outer link plate taken on a section plane perpendicular to the direction of chain elongation and passing through the center of a connecting pin is at least as large as the area of each cross-section of each inner link plate taken on a section plane perpendicular to the direction of chain elongation and passing through the center of a bushing.

When the chain comes into sliding contact with a chain guide, the outer link plates do not come into contact with the chain guide. Therefore, the contact area of the entire chain is decreased, frictional resistance is reduced, and noise and vibration are decreased. In addition, since the cross section of the outer link plate passing through the center of a connecting pin is larger than the cross-sectional area of a section of the inner link plate passing through the center of a bushing, the strength of the part of the outer link plate around the connecting pin is sufficiently large to avoid rupture at the location at which the outer link plate most liable to break. Thus adequate rupture strength of the chain as a whole can be maintained.

In a preferred embodiment of the chain, the radius of curvature of each side of the narrow portion of each outer link plate is larger than the radius of each connecting pin, and the radius of curvature of each of the end portions of each outer link plate is at least as large as the radius of curvature of each side of the narrow portion of the last-mentioned outer link plate. Accordingly, the rupture strength of the narrowest portion of the outer link plate can be made greater than the rupture strength around the connecting pin in the outer link plate even though the outer link plate is formed in such a way as to ensure that it does not come into contact with the chain guide. Maintenance of the above-described radius relationship results in a still further improvement in the overall rupture strength of the chain.

Additionally, in a preferred embodiment of the chain, the area of each cross-section of each outer link plate, taken on a section plane perpendicular to the direction of elongation of the chain and passing through the narrowest part of the narrow middle portion of the outer link plate is at least as large as the area of each section of each inner link plate taken on a section plane perpendicular to the direction of elongation of the chain and passing through the center of a bushing.

When the cross section of the narrow intermediate part of an outer link plate is at least as large as the cross-section of an inner link plate at the location of the bushing, the rupture strength at the narrowest portion of the outer link plate becomes larger than the rupture strength around the connecting pin in the outer link plate. Therefore, the rupture strength of the chain as a whole, can be maintained.

### BRIEF DESCRIPTION OF THE DRAWINGS

FIG. 1 is a schematic view of the timing drive of an internal combustion engine timing drive in which the chain of the invention can be incorporated;

FIG. 2 is an exploded perspective view of a portion of a chain according to the invention;

FIG. 3 is a side elevational view of a portion of the chain;

FIG. 4a is a side elevational view of an inner link plate of the chain;

FIG. 4b is a side elevational view of an outer link plate of the chain;

FIG. 5a is a perspective view of an outer link plate;

FIG. 5b is a vertical section taken on plane 5b-5b in FIG. 5a;

FIG. 5c is a vertical section taken on plane 5c-5c in FIG. 5a;

FIG. 6a is a perspective view of an inner link plate;

FIG. 6b is a vertical section taken on plane 6b-6b in FIG. 6a.

FIG. 7 is a side elevational view of an outer link plate; showing the relationship between the profile of the outer link plate and that of an inner link plate;

FIG. 8a is a plan view of a portion of the chain according to the invention, including a schematic auxiliary view showing bending of a connecting pin and bending of an outer link plate;

FIG. 8b is a plan view of a portion of a conventional chain, including an auxiliary showing bending of a connecting pin and the generation of a clearance at the location where the connecting pin fits into a pin hole in an outer link plate;

FIG. 9 is a plan view, partly in section, of portion of a conventional chain;

FIG. 10a is an exploded perspective view of an outer link plate of a conventional chain;

FIG. 10b is a perspective view of an inner link plate of a conventional chain;

FIG. 11 is a side elevational view of a portion of a conventional chain; and

FIG. 12 is a side elevational view of another conventional chain.

### DETAILED DESCRIPTION OF THE PREFERRED EMBODIMENTS

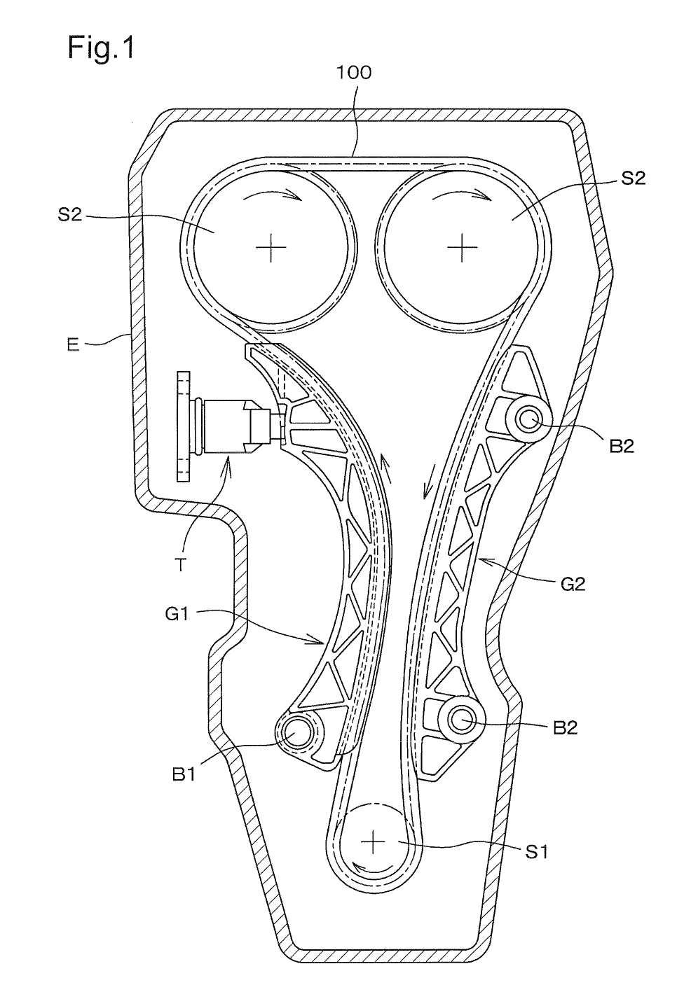

As shown in FIG. 1, in the timing transmission of an internal combustion engine E, a chain 100 according to the invention is wound around a crankshaft sprocket S1 and camshaft sprockets S2. The chain comes into sliding contact with a tensioner lever G1. A tensioner T urges lever G1, which is pivoted on a bolt B1, against a span of the chain traveling from sprocket S1 toward a sprocket S2. The opposite span of the chain, which travels from the other camshaft sprocket S2 toward the crankshaft sprocket S1, slides on a fixed guide G2, which is secured to the engine block by bolts B2.

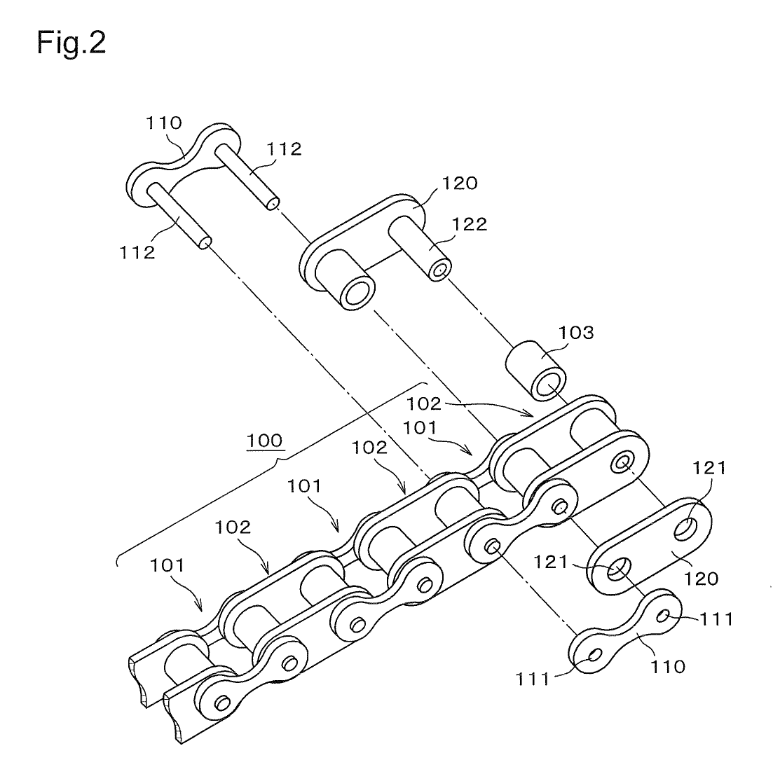

As shown in FIG. 2, The chain 100 includes, pairs of opposed, spaced, inner link plates 120, and cylindrical bushings 122 whose respective both end portions are press-fit into bushing holes 121 of the inner link plates 120. The chain also includes pairs of opposed, spaced, outer link plates 110 disposed in overlapping relation ship with, and on the outsides of, the inner link plates 120. Connecting pins 112 extend rotatably through the bushings 122 and their opposite ends are press-fit into pin holes 111 of the outer link plates 110. The inner link plates and the bushings fitted thereto form inner links 102, and the outer link plates and the connecting pins fitted thereto form outer links 101. The inner and outer links are arranged in alternating, overlapping relationship, and connected to one another by the connecting pins of the outer links, each of which extends through a bushing of an adjacent inner link. In the embodiment shown, which is a roller chain, rollers 103 fit rotatably on the bushings 122.

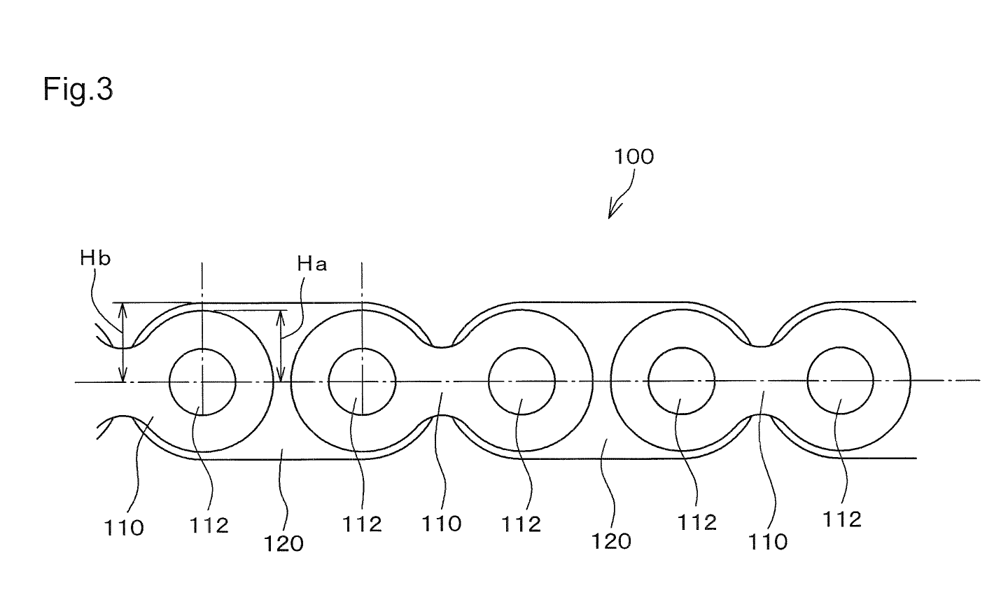

The outer link plate 110 is shaped like a gourd, and has a narrow middle portion in the direction of chain elongation as shown in FIG. 3. Its back height Ha, is the perpendicular distance from a chain pitch line extending through centers of the connecting pins 112 to the outermost part of an edge of the plate 110, which is preferably directly above the center of the connecting pin. Similarly, the back height Hb of the inner link plate 120 is the perpendicular distance from the chain pitch line to the outermost part of the outer edge of the inner link plate 120. Back height Ha of the outer link plate is less than the back height Hb of the inner link plate. Therefore, the outer link plates 110 do not come into contact with a chain guide, and frictional resistance between the chain and the chain guide is reduced.

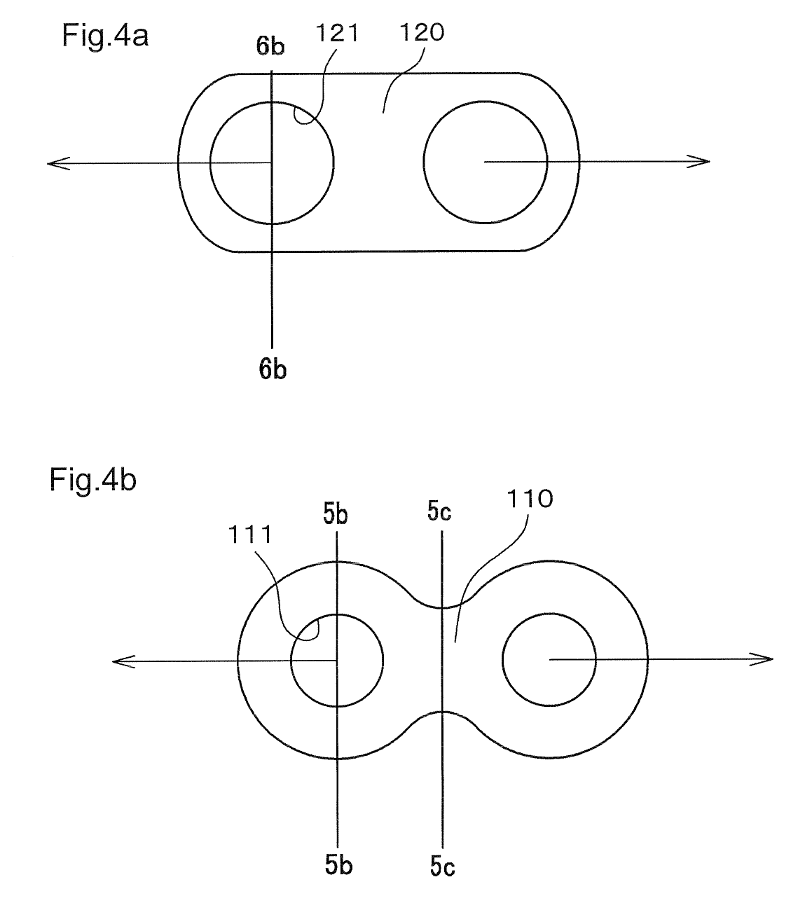

Tension applied to the chain 100 acts through the bushings on the bushing holes 121 of the inner link plates 120 along the directions indicated by arrows in FIG. 4a. Similarly tension applied to the chain acts on the pin holes 111 of each outer link plate 110 in the directions shown by the arrows in FIG. 4b.

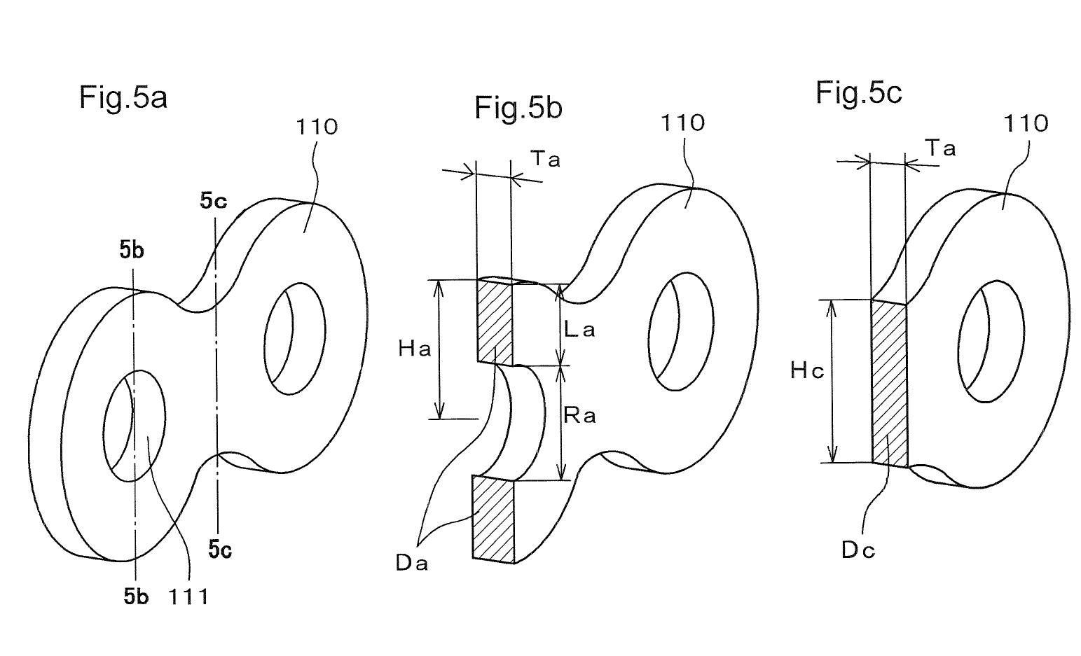

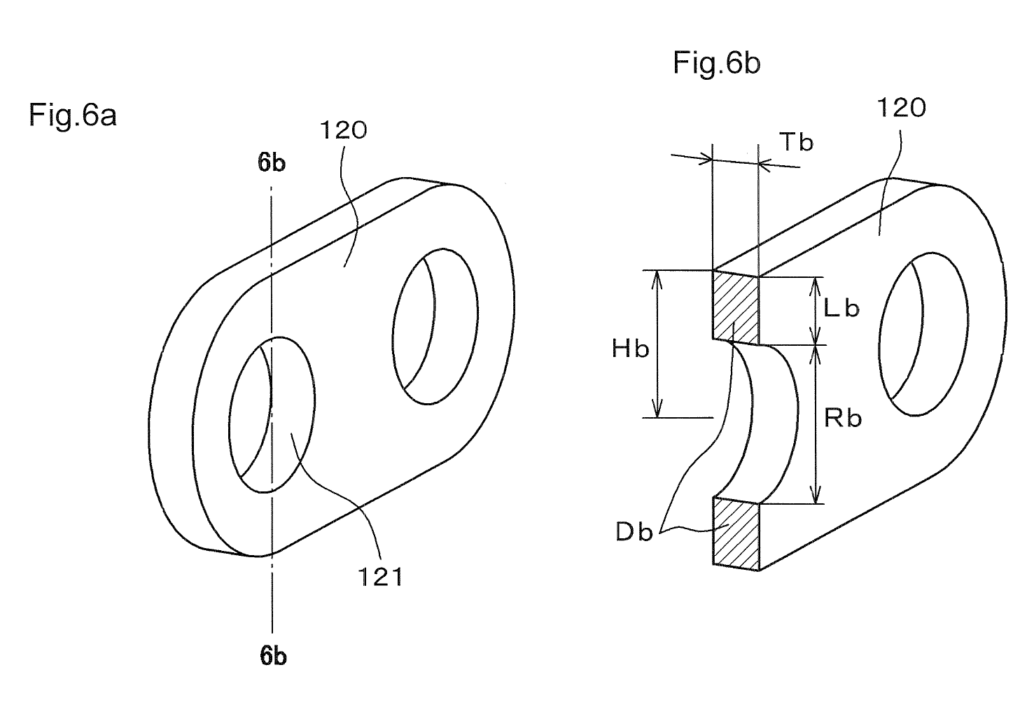

Portions of the link plates having a small cross-sectional area perpendicular to the directions in which tension is applied to the inner and outer link plates are indicated by section planes 6b-6b in FIGS. 4a and 6a, and by section planes 5b-5b and 5c-5c in FIGS. 4b and 5a, respectively. The cross-sectional area of the inner link plate cut by section plane 6b-6b consists of two parts, shown in FIG. 6b. These two parts have a total area Db. The cross-sectional area of the outer link plate cut by section plane 5b-5b also consists of two parts as shown in FIG. 5b, and these two parts have a total area Da. The cross-sectional area cut by section plane 5c-5c is seen in FIG. 5c and consists of a single part having an area Dc. The locations at which these cross-sections are taken are the locations at which breakage due tensile force is most likely to occur.

The relationships of the total cross sectional area Db of the inner link plate, as shown in FIG. 6b, to the total cross sectional area Da of the outer link plate shown in FIG. 5b, and to the cross-sectional area Dc of the outer link plate as shown in FIG. 5c, are preferably as follows:

Db≦Da

Db≦Dc

When the first, and preferably with both, of these relationships apply, even though the outer link plate 110 is gourd-shaped and has a narrow middle portion, and a back height Ha lower than the back height Hb of the inner link plate 120, the overall rupture strength of the chain 100 is maintained.

The dimensions of the respective portions of the inner link plate 120 and the outer link plate 110 are defined as follows.
Ha is the back height of inner link plate.
Hb is the back height of outer link plate.
Hc is the height of the narrowest portion of the outer link plate.
Ra is the diameter of a pin hole, which is equal to the diameter of connecting pin.
Rb is the diameter of a bushing hole, which is equal to the diameter of a bushing.
Ta is the thickness of inner link plate.
Tb is the thickness of outer link plate.
La is the width of an outer circumferential portion of an outer link plate surrounding a pin hole, measured perpendicular to the chain pitch line along a line intersecting the center of the pin hole.
Lb is the width of an outer circumferential portion of an inner link plate surrounding a bushing hole, measured perpendicular to the chain pitch line along a line intersecting the center of the bushing hole.

When the above dimensions are taken into account, the above-mentioned cross-sectional areas Da, Db and Dc are as follows.

Da=2×La×Ta

La=Ha−(Ra/2)

Thus, the following expression is satisfied.

Da=2×(Ha−(Ra/2)×Ta=2×(Ha×Ta)−(Ra×Ta)

Similarly,

Db=2×(Hb−(Rb/2)×Tb=2×(Hb×Tb)−(Rb×Tb)

and

Dc=Ha×Ta

The following expressions must be satisfied so that cross-sectional areas satisfy the above-mentioned relationships Db≦Da and Db≦Dc:

2×(Ha×Ta)−(Ra×Ta)>2×(Hb×Tb)−(Rb×Tb)

Hc×Ta≧2×(Hb×Tb)−(Rb×Tb)

When the thicknesses of the inner link plate 120 and the outer link plate 110 are the same, that is, when Ta=Tb, the above expressions simplify to expressions are satisfied:

2×(Ha−Ra)≧2×(Hb−Rb)

Hc≧2×(Hb−Rb)

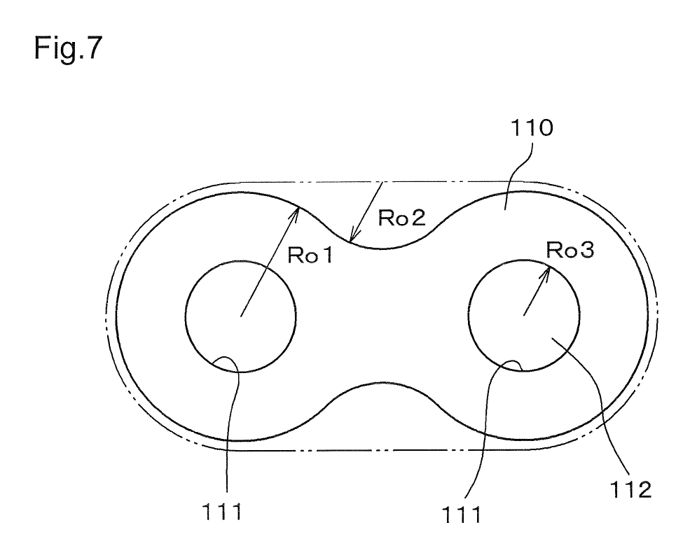

Furthermore, as shown FIG. 7, since the radius of curvature Ro2 of the narrow portion of the outer link plate 110 is larger than the radius Ro3 of the connecting pin 112, and the radius of curvature Ro1 of both end portions of the outer plate 110 is larger than the radius of curvature Ro2 of the narrow portion, when the chain 100 comes into sliding contact with a chain guide, the narrow portions of its outer link plates 110 do not come into contact with the chain guide.

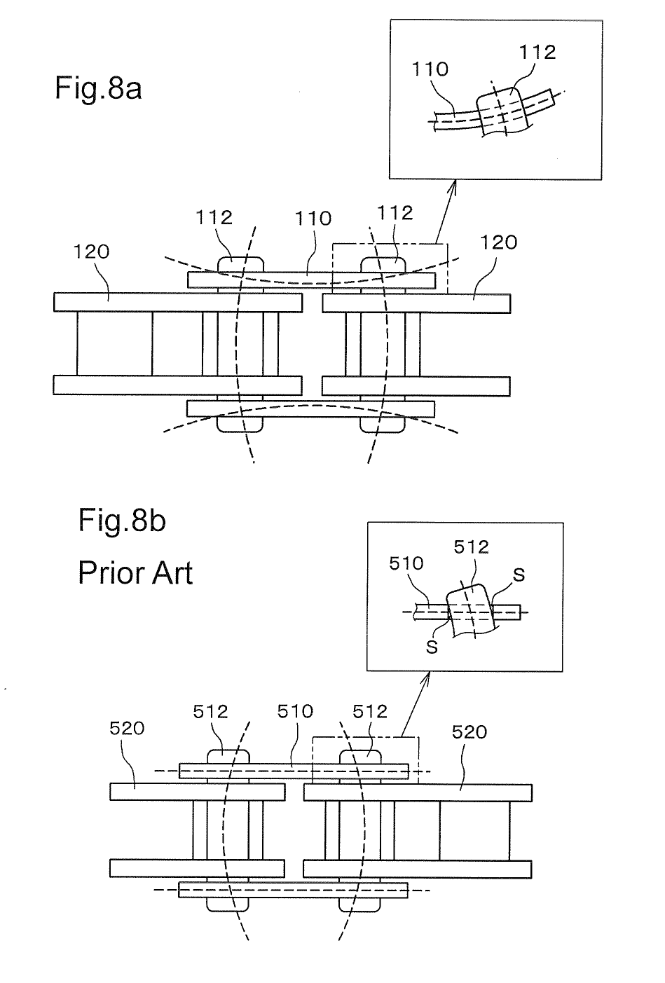

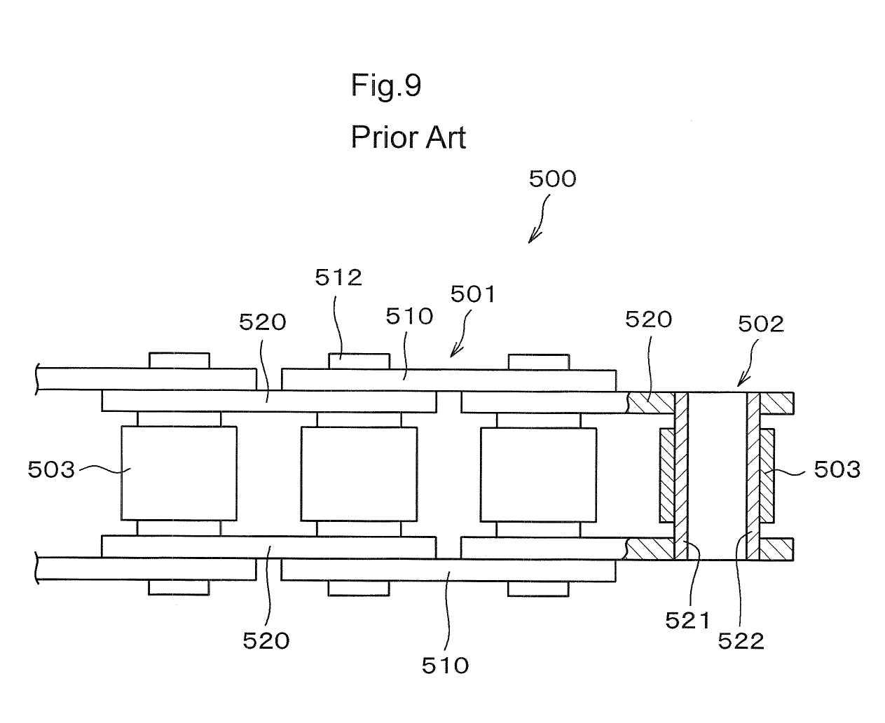

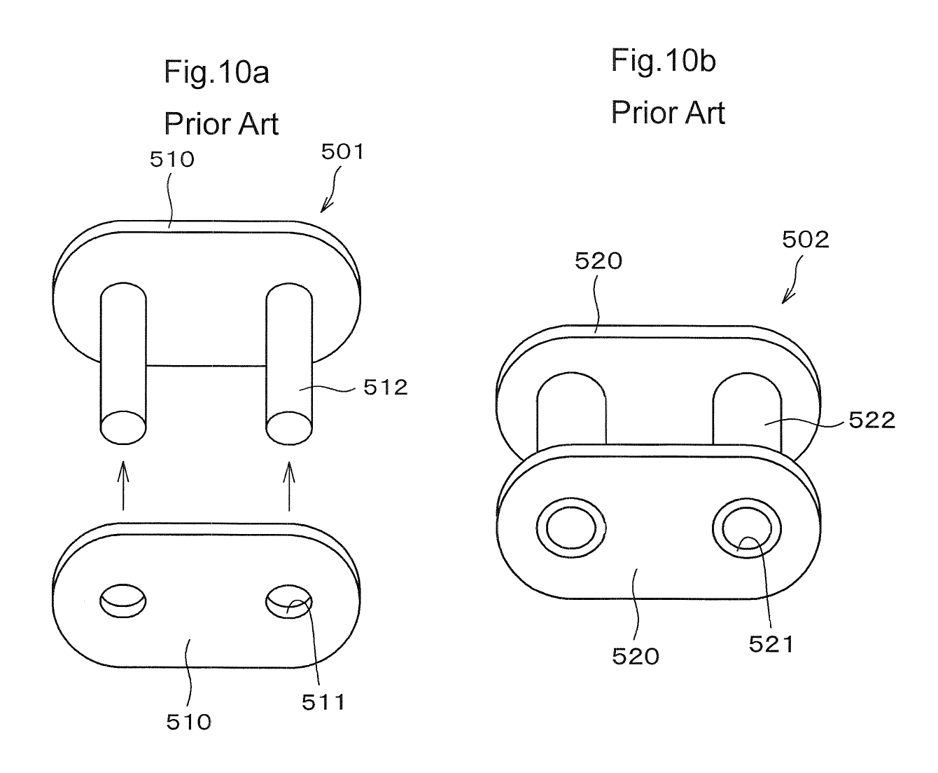

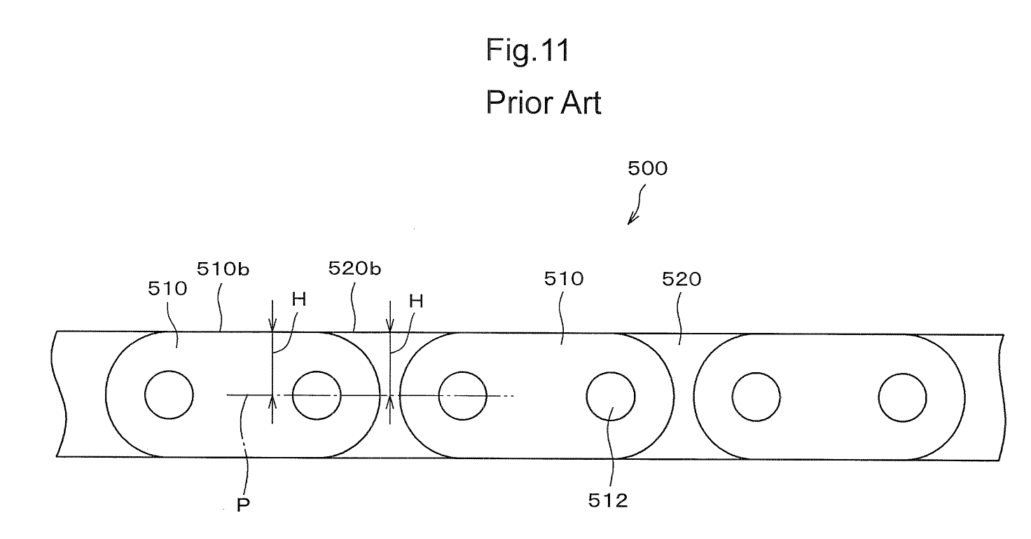

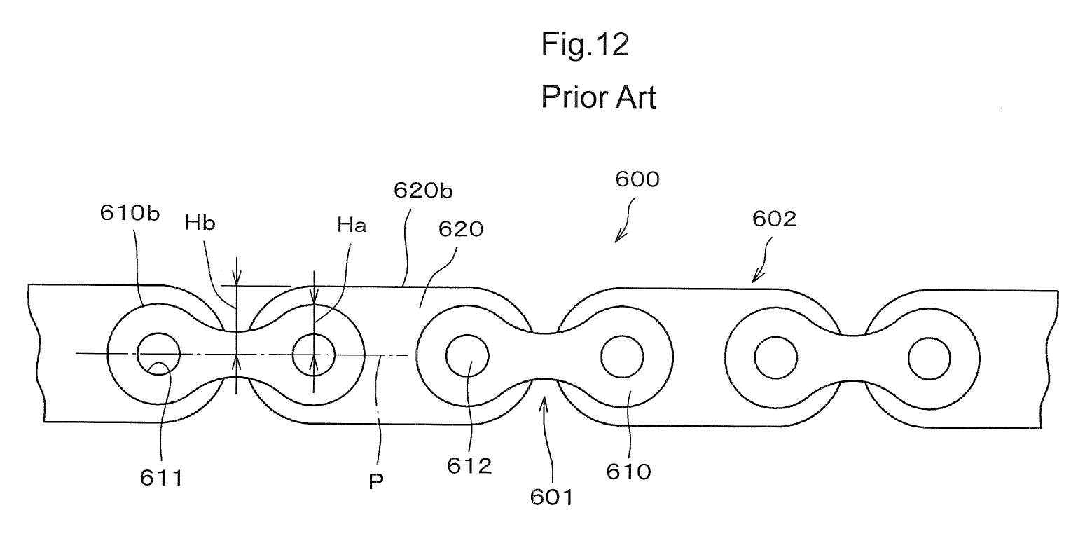

When tension is applied to a conventional chain 510, as shown in FIG. 8b, the connecting pins 512 are bent as shown by broken lines. Since the outer link plates 510 have a high degree of rigidity, the do not bend along with the connecting pins, and consequently clearances S appear between the pins and the pin holes of the outer link plates at the locations at which the pins are press-fit into the pin holes. As a result, the connecting pins can become loose, and damage to the chain can result from changes in chain tension.

As shown in FIG. 8a, in the chain according to the invention, since the outer link plates 110 have a gourd shape, with a narrow middle portion, and the back height Ha of the outer link plates is less than a back height Hb of an inner link plates 120, the rigidity of the outer link plates is reduced and they bend along with the connecting pins, as shown by broken lines in FIG. 8a. Thus the close press fit relationship between the connecting pins 112 and their pin holes 111 of the outer link plates 110 is maintained, and damage to the chain due to loosening of the pins is prevented.

The contact area between the chain and a chain guide is reduced so that transmission power loss due to friction is reduced. As a result, noise and vibration are reduced, and, at the same time, the chain maintains good rupture strength.

Although the chain described is a roller chain having rollers 103, the advantages of the invention can also be realized in a rollerless bushing chain.

What is claimed is:

1. An elongated chain comprising a series of inner and outer links arranged alternately along the length of the chain and interconnected with one another to form an endless loop, each inner link comprising a pair of opposed, spaced, inner link plates with a pair of cylindrical bushings having end portions press-fit into bushing holes in the link plates, and each outer link comprising a pair of opposed, spaced, outer link plates with a pair of connecting pins each press-fit into pin holes in both outer link plates, the plates of each of the outer links overlapping plates of two adjacent inner links, and the pins of each outer link extending rotatably through bushings of two adjacent inner links, wherein each said outer link plate is a gourd-shaped plate having, along the direction of elongation of the chain, a narrow middle portion between two end portions larger than the middle portion, wherein the back height of each outer link plate is smaller than the back height of each of the inner link plates, and wherein the area of each cross-section of each outer link plate taken on a section plane perpendicular to the direction of chain elongation and passing through the center of a connecting pin is at least as large as the area of each cross-section of each inner link plate taken on a section plane perpendicular to the direction of chain elongation and passing through the center of a bushing.

2. A chain according to claim 1, in which the radius of curvature of each side of the narrow portion of each outer link plate is larger than the radius of each said connecting pin, and the radius of curvature of each of the end portions of each outer link plate is larger than the radius of curvature of each side of the narrow portion of the last-mentioned outer link plate.

3. A chain according to claim 1, in which the area of each cross-section of each outer link plate, taken on a section plane perpendicular to the direction of elongation of the chain and passing through the narrowest part of the narrow middle portion of the outer link plate is at least as large as the area of each section of each inner link plate taken on a section plane perpendicular to the direction of elongation of the chain and passing through the center of a bushing.

4. A chain according to claim 3, in which the radius of curvature of each side of the narrow portion of each outer link plate is larger than the radius of each said connecting pin, and the radius of curvature of each of the end portions of each outer link plate is larger than the radius of curvature of each side of the narrow portion of the last-mentioned outer link plate.
